(19) United States
(12) Patent Application Publication
(10) Pub. No.: US 2020/0150626 A1
(43) Pub. Date: May 14, 2020

(54) RE-SHAPING PROCEDURE

(71) Applicant: GF Casting Solutions Altenmarkt GmbH & Co. KG, Altenmarkt (AT)

(72) Inventors: Heinrich Marko, Admont (AT); Goekhan Sonuc, Bad Saulgau (DE)

(21) Appl. No.: 16/676,490

(22) Filed: Nov. 7, 2019

(30) Foreign Application Priority Data
Nov. 9, 2018 (EP) 18 205 431.2

(51) Int. Cl. G05B 19/4099

(52) U.S. Cl. CPC G05B 19/4099; G05B 2219/35134; G05B 2219/35017

(57) ABSTRACT

A method for re-shaping a shape of a plastically deformable component that is preferably embodied from a metal material includes: creating a three-dimensional desired model of the component; designing a finite element model (FEM model) of the desired model of the component; capturing a three-dimensional geometry of a deformed actual component; determining a deviation of the actual component with respect to the desired model; deforming by applying forces to calculated positions of the component; and checking and comparing the actual component with the desired model after the deforming. Forces that are applied for the deforming and the calculated positions for introducing the forces to the component are determined on a basis of the FEM model.

### CROSS-REFERENCE TO PRIOR APPLICATION

Priority is claimed to European Patent Application No. EP 18205431.2, filed on Nov. 9, 2018, the entire disclosure of which is hereby incorporated by reference herein.

### FIELD

The invention relates to a method for re-shaping the shape of a plastically deformable component that is preferably embodied from a metal material, said method including:
creating a three-dimensional desired model of the component;
designing a finite element model (FEM) of the desired model of the component;
capturing the three-dimensional geometry of the deformed actual component; preferably by means of scanning;
determining the deviation of the actual component with respect to the desired model;
deforming by means of applying forces to calculated positions of the component;
checking and comparing the actual component with the desired model after the deformation procedure.

### BACKGROUND

The prior art discloses a method for re-shaping a component in which the actual component is measured as precisely as possible and is compared to a three-dimensional desired model. The dimensional deviations are displayed to an operator with the aid of a computer program, said operator manually correcting these sites by means of applying a pulling force or pushing force. In order to obtain an actual component that corresponds to the dimensional requirements, in general eight to fifteen such deformation procedures and testing procedures or cycles are to be performed, which requires a large expenditure of time.

DE 196 11 897 discloses a method for bending or re-shaping metal workpieces, wherein the actual shape of the workpiece and the deviation from the desired shape are determined by means of a force sensor and a travel sensor, which detects the jitters. During the course of the further bending procedure, the values that are determined for calculating the springback and therefore for calculating the remaining deformation after relief of the strain are evaluated in a computer-aided manner and the deformation procedure is terminated as soon as the calculated remaining deformation corresponds to achieving the desired shape. However, such a computer-aided method requires a significant outlay of time and instrumental outlay owing to the jitters that are determined with the aid of a force sensor and travel sensor.

### SUMMARY

In an embodiment, the present invention provides a method for re-shaping a shape of a plastically deformable component that is preferably embodied from a metal material, the method comprising: creating a three-dimensional desired model of the component; designing a finite element model (FEM model) of the desired model of the component; capturing a three-dimensional geometry of a deformed actual component; determining a deviation of the actual component with respect to the desired model; deforming by applying forces to calculated positions of the component; and checking and comparing the actual component with the desired model after the deforming, wherein forces that are applied for the deforming and the calculated positions for introducing the forces to the component are determined on a basis of the FEM model.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 illustrates a flow diagram of the sequence of the method in accordance with the invention.

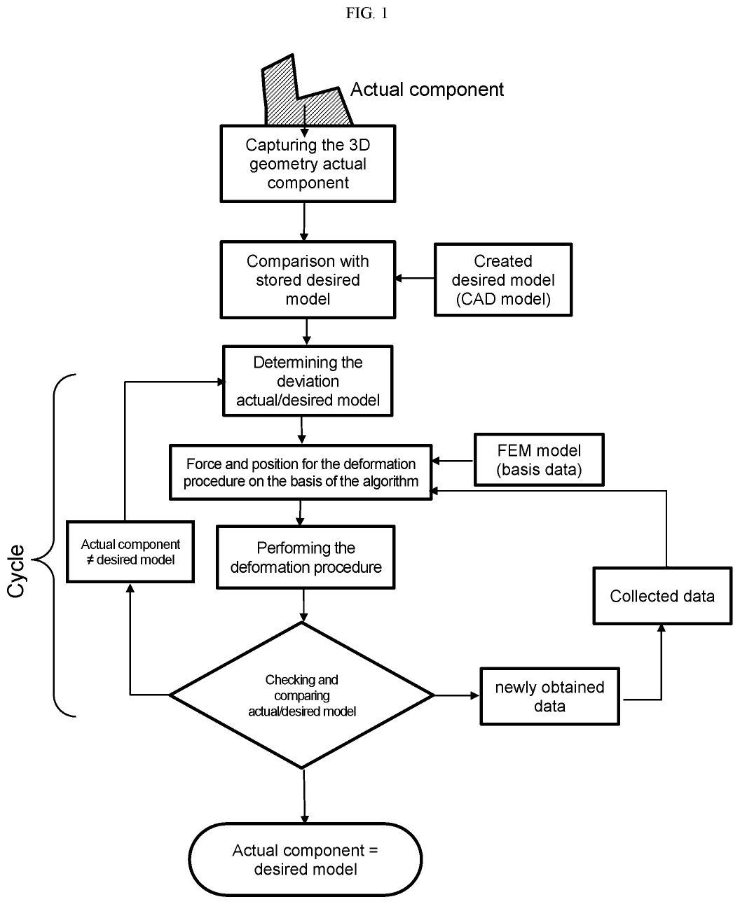

### DETAILED DESCRIPTION

In an embodiment, the present invention provides a method in which the procedure of re-shaping a component until the finished re-shaped component is achieved takes place rapidly and autonomously in that as few as possible testing procedures and comparison procedures are required.

In an embodiment, this object is achieved in accordance with the invention by virtue of the fact that the forces that are applied for the deformation procedure and the calculated positions for introducing the forces to the component are determined on the basis of the FEM.

The method in accordance with the invention for re-shaping the shape of a plastically deformable component that is preferably embodied from a metal material includes creating a three-dimensional desired model of the component, preferably as a CAD model.

As a further step, the method includes designing a finite element model (FEM model) of the desired model of the component. The FEM model may simulate the behaviour of the component under the influence of forces. In general, such FEM models are used for dimensioning components and for their design so that it is possible to create an optimized shape in the case of prevailing forces and other influences.

The deformed actual component or its three-dimensional geometry is captured preferably by means of scanning, wherein the captured data is preferably at least temporarily stored in a computer or cloud. In general, the actual component arrives directly after the production procedure so as to capture the geometry. This optimizes the complete production procedure of a component until the component is re-shaped. The captured and created data of this method or of the actual component, of the desired model and of the FEM model may preferably also be collected in a cloud and may be included as empirical values for other re-shaping methods. Wherein the data from the production procedure, be it material data, casting data, heat treatment data or other data, which may be used for the method, is also included in the shaping procedure, wherein the data is preferably collected in a cloud and accessed by the different systems and may be combined with one another.

The captured data renders it possible to determine the deviation of the actual component with respect to the desired model. The deviation of the shape may be determined on the basis of the captured three-dimensional geometry of the actual component and the desired model that is created. It is preferred that computer programs are used for this purpose, which render it possible to perform a rapid implementation and to collate the captured and created data.

It is possible on the basis of the deviation that is determined to perform a defined deformation procedure by means of applying forces to calculated positions of the actual component. The deviations in shape may be displayed optically by the system and a deformation procedure may be performed based on said deviations.

After a deformation procedure is performed, the actual component is checked and compared with the desired model. If the actual component does not achieve the shape of the desired model, a deformation procedure is again performed on the basis of the newly-determined deviations between the actual component and the desired model. A check and a comparison between the actual component and the desired model is likewise subsequently performed again, the cycle was therefore performed again. These procedures or cycles are repeated so often until the actual component corresponds to the desired model.

In accordance with the present invention, this method is optimized in that the forces that are applied for the deformation procedure and the positions that are calculated for introducing the forces to the actual component are determined on the basis of the FEM model or this forms a basis with respect to the first deformation. It is preferred that the system or the computer specifies defined forces that are introduced at the respectively calculated positions in order to achieve a calculated deformation of the actual component on the basis of the FEM model. It is possible, by means of this specification of defined forces that act upon the actual component and also the precise position where the forces are to be introduced, for the deformation that occurs on the actual component to be predefined by means of the FEM model. As a consequence, the number of cycles may be reduced since, with the aid of the FEM model, an actual component that is close to the desired model is already achieved after the first cycle by means of determining the deformation that is to be expected on the basis of the predefined forces and positions for introducing the forces.

It is advantageous if the FEM model is used as the basis of the first re-shaping procedure. On this basis, a first re-shaping procedure is performed that by means of the stored FEM model may determine relatively precisely the deformation that is to be expected on the actual component.

In order to optimize the results or the re-shaping procedure, the data, which is captured after each deformation procedure and subsequent checking procedure and comparison procedure, such as data relating to forces that are applied, positions, the achieved deformation etc., is captured by the system or computer and thus the forces and positions which are applied during the next cycle are optimized and also, in the case of the subsequent components, the optimized forces and positions are applied from the start, so that in the best case one deformation procedure would suffice in order to re-shape the actual component so that said actual component corresponds to the desired model. Such data may be stored in a cloud and may be exchanged between the systems.

It is preferred that for this optimization the forces that are applied so as to deform the component and the positions that are calculated are determined by means of an algorithm. In other words, after each deformation in which forces and positions have been specified and after the actual component has been checked and compared, the data is captured and optimized in the system or computer by means of an algorithm with the result that the more cycles or the more actual components that are re-shaped, the fewer cycles are required since the method is optimized by means of the algorithm or the artificial intelligence. In other words, in the optimum case, only one further cycle is required, however, on the basis of empirical values it has been shown that a reduction in the number of cycles to three to six is particularly effective in comparison to the modern day prior art where a cycle number of below 8 procedures is not to be expected.

It is preferred that the algorithm for determining the forces and the positions for introducing the forces is optimized with reference to the newly obtained data after each checking procedure and procedure of comparing the actual model with the three-dimensional desired model. The newly obtained data shows the effective deformation of the actual component with reference to the forces that are applied to the defined positions. It is possible on the basis of the newly obtained data to optimize and refine the basic data of the FEM model, said basic data having been applied for the first cycle. Each implementation consequently refines and optimizes the data that is required for the optimal deformation procedure as a result of which the cycles may be reduced and the process time is shortened. The method is consequently self-learning and optimizes itself or the algorithm optimizes itself.

It is advantageous if the algorithm for determining the forces and the positions for introducing the forces is optimized with reference to the collected data after each checking procedure and procedure of comparing the actual component with the three-dimensional desired model, wherein the collected data is preferably formed from the newly obtained data of the individual cycles. It is advantageous if yet further data in relation to the actual components is introduced, said data relating to preceding procedures such as the production procedure or a possible heat treatment. All this data may be collected in a cloud and may be introduced into the method in accordance with the invention or into the optimization of the algorithm.

The invention is characterized by virtue of the fact that the forces are applied to the actual component by means of robots. It is possible, by means of applying the forces to the actual component by means of robots, for the force or the level of the force to be implemented and reproduced precisely. Moreover, the robot may be monitored during the implementation for whether the force is applied precisely. It is preferred that the data is immediately captured by the system and said data may then be processed in the system by means of the algorithm so as to optimize the data with regard to the deformation that is achieved.

It is advantageous if the forces are applied to the actual component as pulling forces and pushing forces. This renders possible specific deformations of the actual component in order to obtain the required shape of the desired component.

The method in accordance with the invention is preferably applied for structural parts in automotive engineering since said structural parts are usually thin-walled and therefore easily warp during production and must subsequently be re-shaped. Cast components are especially preferred for such a method since these thin-walled components that are usually produced from soft metal warp during the casting or moulding procedure and must subsequently be subjected to a re-shaping procedure. Moreover, such parts involve a high number of units, which makes it economically worthwhile to optimize the procedure in such a manner.

All the possible embodiments may be freely combined with one another.

The actual component or its three-dimensional geometry is captured digitally, preferably by means of scanning the geometry. This data is stored and compared to the desired model, which has been digitally created preferably as a CAD model. The comparison shows the deviations of the geometries with respect to one another. It is possible on the basis of the FEM model that is stored in the system to determine which forces must be applied to which positions in order to achieve the geometry of the desired model, said FEM model having been created on the basis of the three-dimensional desired model and the deviations of the actual component with respect to the desired model. The system then performs a deformation procedure of the actual component on the basis of the forces that are calculated and the positions for introducing the forces. During the first cycle, these forces and positions are based preferably exclusively on the FEM model, in each further cycle, whether it is on the same component or on another identically-shaped component which the method is implemented on, the data and consequently the positions and the forces that are applied are already optimized by means of empirical values of previously re-shaped components. In other words, after the first deformation procedure the actual component is compared to the desired model and the data is captured, wherein the data is stored in the system or computer or also in a cloud and preferably supplemented with other data such as material data etc. If the desired shape of the actual component is not achieved, the actual component is subjected to a further cycle. The deviation with respect to the desired model is consequently determined again and a deformation procedure is again performed by means of the newly obtained data and the collected data, which is provided in the system by means of previous cycles, said deformation procedure that is performed again being determined by means of an algorithm that is optimized after each cycle and as a consequence forms a self-learning method. The repetition of the cycles ends if the actual component corresponds to the desired model.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for re-shaping a shape of a plastically deformable component that is preferably embodied from a metal material, the method comprising:
creating a three-dimensional desired model of the component;
designing a finite element model (FEM model) of the desired model of the component;
capturing a three-dimensional geometry of a deformed actual component;
determining a deviation of the actual component with respect to the desired model;
deforming by applying forces to calculated positions of the component; and
checking and comparing the actual component with the desired model after the deforming,
wherein forces that are applied for the deforming and the calculated positions for introducing the forces to the component are determined on a basis of the FEM model.

2. The method according to claim 1, wherein the FEM model is used as a basis of a first re-shaping procedure.

3. The method according to claim 1, wherein the forces that are applied so as to deform the component and the calculated positions are determined by an algorithm.

4. The method according to claim 3, wherein the algorithm is optimized with reference to newly obtained data after each checking and comparing of the actual component with the three-dimensional desired model.

5. The method according to claim 3, wherein the algorithm is optimized with reference to collected data after each checking and comparing of the actual component with the three-dimensional desired model.

6. The method according to claim 1, wherein the forces are applied to the actual component by robots.

7. The method according to claim 1, wherein the forces applied to the actual component comprise pulling forces and pushing forces.

8. The method according to claim 1, wherein the components comprise thin-walled parts.

9. The method according to claim 1, wherein capturing the three-dimensional geometry of the deformed actual component comprises scanning.

10. The method according to claim 8, wherein the thin-walled parts comprise structural parts used in automotive engineering.

11. The method according to claim 8, wherein the thin-walled parts comprise cast components.

12. The method according to claim 11, wherein the cast components comprise structural parts used in automotive engineering.
